(19) United States
(12) Patent Application Publication
(10) Pub. No.: US 2016/0147894 A1
(43) Pub. Date: May 26, 2016

(54) METHOD AND SYSTEM FOR FILTERING SEARCH RESULTS

(71) Applicant: INSTITUTE FOR INFORMATION INDUSTRY, TAIPEI CITY (TW)

(72) Inventors: CHUN-HUNG LU, Taipei City (TW); JIN-GU PAN, New Taipei City (TW); YI-HSUN LI, Taichung City (TW); TAI-HUNG CHEN, New Taipei City (TW)

(21) Appl. No.: 14/566,675

(22) Filed: Dec. 10, 2014

(30) Foreign Application Priority Data
Nov. 21, 2014 (TW) 103140556

(51) Int. Cl. G06F 17/30

(52) U.S. Cl. CPC G06F 17/30867; G06F 17/30598

(57) ABSTRACT

The present disclosure illustrates a method for filtering search results. The method comprises the steps of: receiving a keyword; searching by the keyword to obtain an initial search result which comprises a plurality of web pages, and searching at least one related word corresponding to the keyword; clustering the related word to generate a clustered result which comprises at least one clustered group; providing the clustered result to an user such that the user selects one clustered group from the clustered group; and filtering the initial search result based upon the selected clustered group to generate a filtered search result.

### FIELD

The instant disclosure relates to a method and system for filtering search results. In particular, to a method and a processing device thereof for filtering search results which cluster search results and provide users choices.

### BACKGROUND

With the development and growth of technology, the Internet has become an indispensable part of life. The popularity of the Internet led to the rapid flow and massive accumulation of information that is mostly obtained via the Internet. Due to rapid growth of the transfer and accumulation of information on the Internet, contents on the Internet included have also increased significantly.

In order to obtain the necessary information from the vast amount of information, users usually apply public search engines such as Google, Yahoo or Baidu, etc. The user can enter a keyword in the search bar provided by the search engine. By searching for technical information contents in the databases of the search engines, search results are provided to the users.

However, current search technology is inconvenient for users because the massive amount of data currently in the Internet covers a wide variety of information, which drives users to input a precise keyword in order to obtain search result with high relevance. In other words, if the user enters a keyword that is not precise, search engine will retrieve search results that may contain many content articles or web pages with low relevance. Thus, the preferred information is not found when displayed in the front of the user. Moreover, even if the user enters a precise keyword, it is still impossible to visit each article or web page due to the enormous amount of content articles or pages which do not fully match with the users' preferences. Therefore, there is a need for a filtration method that further classifies the content articles or web pages obtained by the initial search, so that users can easily find the desired content articles or web pages.

To address the above issues, the inventor strives via associated experience and research to present the instant disclosure, which can effectively improve the limitation described above.

### SUMMARY

The objective of the instant disclosure in accordance with the embodiments is to provide a method and for filtering search results. The method includes the following steps: step a: receiving a keyword; step b: obtaining an initial search result by searching through a search engine in the internet according to the keyword, and searching at least one related word corresponding to the keyword, in which the initial search result includes a plurality of web pages; step c: clustering the related words obtained from the initial search result and generating a clustered result, and in which the clustered result comprises at least one clustered group; step d outputting the clustered result to a user for selecting at least one clustered group; step e: filtering the initial search result based on the selected clustered group to correspondingly generate a filtered search result

The instant disclosure in accordance with the embodiments also provides a processing device. The processing device includes a related word generating module and a clustering unit. The related word generating module receives a keyword input by a user, an initial search result is retrieved by searching through a search engine in the internet, in which at least one related word corresponding to the keyword is searched, and the initial search result includes a plurality of web pages. The clustering unit is electrically connected to the related word generating module, clusters the related words obtained from the initial search result, and generates a clustered result. The clustered result including at least one clustered group. The clustering unit outputs the clustered result to an operational interface for the user to choose one clustered group. The processing device filters the initial search result according to the clustered group selected by the user to correspondingly generate a filtered search result.

In summary, the method for filtering search results and the use of processing device in accordance with the embodiments of the instant disclosure can cluster related words according to the initial search results, and generate clustered results. Users, according to his or her needs, can select the desired cluster group(s) from the provided clustered groups, so that the initial search results can be further filtered and filtered search results that are more preferable to the user are generated.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1A is a schematic diagram illustrating a processing device in accordance with an embodiment of the instant disclosure;

FIG. 1B is a schematic diagram illustrating a processing device in accordance with another embodiment of the instant disclosure;

FIG. 2 is a process flow diagram illustrating the method for filtering and searching in accordance with an embodiment of the instant disclosure;

FIG. 3 is a process flow diagram illustrating the generation of related words in accordance with an embodiment of the instant disclosure;

FIG. 4 is a process flow diagram illustrating the generation of synonyms in accordance with an embodiment of the instant disclosure;

FIG. 5 is a process flow diagram illustrating the clustered results in accordance with an embodiment of the instant disclosure.

### DETAILED DESCRIPTION

The aforementioned illustrations and detailed descriptions are exemplarity for the purpose of further explaining the scope of the instant disclosure. Other objectives and advantages related to the instant disclosure will be illustrated in the subsequent descriptions and appended drawings.

Hereinafter, the concept of the present invention may be embodied in many different forms and should not be construed as limited to the embodiment set forth herein. Rather, the embodiments are provided so that the instant disclosure will be thorough, complete, and will fully convey the scope of the inventive concept by those skilled in the art. For the purpose of viewing, the relative sizes of layers and regions are exaggerated in all drawings, and similar numerals indicate like elements.

Notably, the terms first, second, third, etc., may be used herein to describe various elements or signals, but these signals should not be affected by such elements or terms. Such terminology is used to distinguish one element from another or a signal with another signal. Further, the term “or” as used herein in the case may include any one or combinations of the associated listed items.

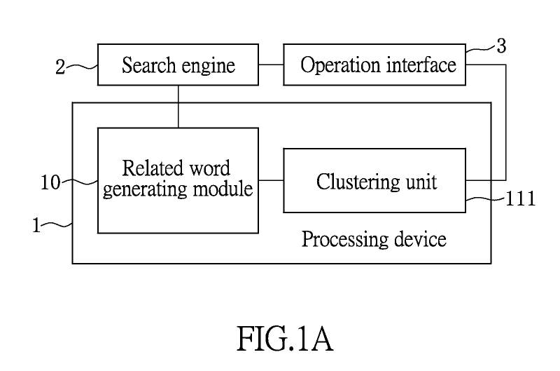

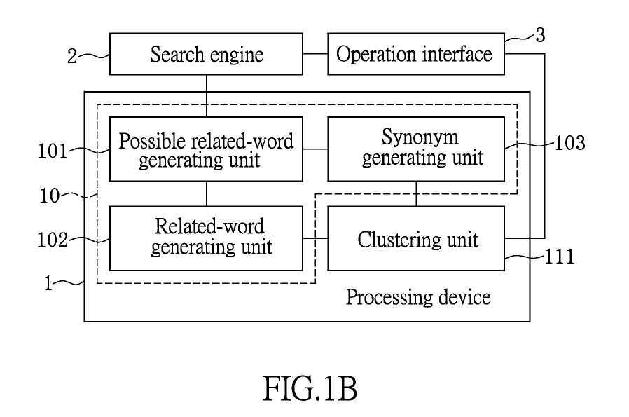

Please refer to FIG. 1A as a schematic diagram illustrating a processing device in accordance with an embodiment of the instant disclosure. The processing device 1 is suitable for the processing unit of any search engine or recommendation system such as Google, Yahoo, Baidu or similar search engines. The processing device 1 includes a related word generating module 10 and a clustering unit 111. The related word generating module 10 receives keywords inputted by a user, obtains an initial search result by searching through the internet with the search engine 2, and searches for at least one related word corresponding to the keyword. The initial search result typically includes a plurality of web pages and similar information. The clustering unit 111 is electrically connected to the related word generating module 10, and clusters the related words according to the initial search results and generates a clustered result. The clustered result can include one or a plurality of clustered groups. The clustering unit 111 outputs the clustered results to the operation interface 3 for displaying, and provides a plurality of clustered groups for the user to select one from the clustered groups. The processing device 1 then filters the initial search result (based on the previously searched web pages) according to the selected clustered group and accordingly generates a filtered search result.

FIG. 1B is schematic diagram illustrating a processing device in accordance with another embodiment of the instant disclosure. The processing device 1, the related word generating module 10, and the clustering unit 111 is similar to that in the previous embodiment. The related word generating module 10 further includes a possible related-word generating unit 101, a related-word generating unit 102, and a synonym generating unit 103. The possible related-word generating unit 101 is electrically connected to the search engine 2, the related-word generating unit 102, and the synonym generating unit 103. The related-word generating unit 102 is electrically connected to the clustering unit 111. The synonym generating unit 103 is electrically connected to the clustering unit 111. The clustering unit 111 is electrically connected to the operation interface 3.

The possible related-word generating unit 101 receives the initial search result generated by the search engine. The initial search result includes a plurality of web pages and similar information. Then the possible related-word generating unit 101 obtains at least one possible related-word from each content article corresponding to each of the web pages. The content article can be any words from the web pages.

The related-word generating unit 102 generates related words according to the frequency of the keyword input by the user and the possible related-word co-occurring within the same sentence of the same content article. When the frequency of the keyword and the possible related-word co-occurring within the same sentence of the same content article is higher than a first threshold value, the possible related-word is classified as a related word. The related word can be synonyms of the keyword, related-words associated with the keyword, or words frequently co-occurring in the same sentence of the same content article.

The synonym generating unit 103 generates an alternative word according to the frequency of the keyword and the possible related-word co-occurring within the same sentence of the same content article. When the frequency of the keyword and the possible related-word co-occurring in the same sentence is lower than a second threshold value and higher than a third threshold value, the possible related-word is classified as the alternative word of the keyword. The synonym generating unit 103 then further determines whether the alternative word is a synonym or an antonym of the keyword. The process to determine whether the alternative word is the synonym or the antonym of the keyword is further disclosed in following section.

When user desires to search for information online, the user can input the keyword in the search column on the operation interface 3. After the search engine 2 receives the keyword, initial search result is obtained by searching online. Then the search engine 2 outputs the initial search result to the related word generating module 10, so that the related word generating module 10 can search related words corresponding to the keyword according to the initial search result.

Specifically, after the possible related-word generating unit 101 of the related word generating module 10 receives the initial search result, the possible related-words corresponding to the content articles are obtained according to the plurality of content articles of the respective web pages in the initial search result. The possible related-word generating unit 101 outputs the possible related-words to the related-word generating unit 102 and the synonym generating unit 103.

The related-word generating unit 102 calculates the frequency of the keyword and each possible related-word co-occurring in the same sentence of the corresponding content article, and determines degree of similarity between the keyword and each one of the possible related-words according to the calculated results. For example, one possible related-word (such as the first possible related-word) in a plurality of possible related-words is first selected from the related-word generating unit 102. When the frequency of the keyword and the first possible related-word co-occurring in the same sentence of the corresponding content article is higher than the first threshold value, the degree of similarity between the first possible related-word and the keyword is high. Then the related-word generating unit 102 determines that the first possible related-word is a related-word associated with the keyword and the first possible related-word is classified as a related word. Notably, the first threshold value is not limited to the examples provided in the embodiment, users can also set the first threshold value on their own or generate values according to related information in the art to determine the degree of similarity between the possible related-word and the keyword.

Moreover, the related-word generating unit 102 non-repeatedly selects another possible related-word (such as a second possible related-word) from the plurality of possible related-words, and determines the degree of similarity between the second possible related-word and the keyword. Repeating the steps from above until all possible related-words are selected by the related-word generating unit 102. In other words, the related-word generating unit 102 can determine which possible related-words from all the possible related-words have high degree of similarity with respect to the keyword, and classify the possible related-words having high degree of similarity with respect to the keyword as related words of the keyword.

The synonym generating unit 103 calculates the frequency of the keyword and each possible related-word co-occurring in the same sentence of the corresponding content article and determines the degree of similarity between the keyword and each possible related-word according to the calculated result. The synonym generating unit 103 assumes that the keyword and the synonyms or antonyms of the keyword do not co-occur in the same sentence, as such, the synonym generating unit 103 determines the possible related-words having a low degree of similarity with respect to the keyword as synonyms or antonyms of the keyword.

The synonym generating unit 103 first selects one possible related-word (such as first possible related-word) from the plurality of possible related-word. When the frequency of the keyword and the first possible related-word co-occur in the same sentence corresponding to the respective content article is lower than a second threshold value and higher than a third threshold value, the degree of similarity between the keyword and the first possible related-word is low. The second threshold value is less than the first threshold value, and the third threshold value is less than the second threshold value. At this time, the synonym generating unit 103 determines the first possible similar term as the alternative word of the keyword. Notably, the instant disclosure does not limit the value of the second and the third threshold values, user can set the second and third threshold values or generate the value according to related information from known technology in order to determine the degree of similarity between the possible related-words and the keyword.

Notably, the synonym generating unit 103 determines whether the possible related-word will be the alternative word according to the second and third threshold values in the instant embodiment, however, the instant disclosure do not limit thereto. In other embodiments, the synonym generating unit 103 does not set the second and third threshold values, rather, the possible related-words that have a co-occurring frequency with respect to the keyword in the same sentence of the corresponding content article lower than the first threshold value are directly determined to be alternative words.

Successively, the synonym generating unit 103 further determines whether the alternative words are the synonyms or the antonyms of the keyword. The synonym generating unit 103 determines whether the alternative words are the synonyms or the antonyms of the keyword according to both the parts of speech and the sentence structures between the keyword and the alternative words. For example, user inputs the keyword “car”, and the keyword is found in the sentence “drive a red car”. The synonym generating unit 103 then searches the location of the alternative word, and obtains a corresponding sentence of “operate a white roadster”. The synonym generating unit 103 first determines the keyword “car” as a noun, then separates the verb “drive” from the adjective “red” that are both related to the keyword “car”. The synonym generating unit 103 determines the verb “operate” and the adjective “white” that are related to the alternative word “roadster” according to the sentence structures of the two sentences. Since the related-verbs “operate” and “drive”, while related-adjectives “red” and “white” are used to modify the nouns in the two sentences, the synonym generating unit 103 determines the alternative word “roadster” as the synonym of the keyword “car”.

When the alternative word is determined to be the synonym of the keyword, the synonym generating unit 103 classifies the synonym as a related word. When the alternative word is determined to be the antonym of the keyword, the synonym generating unit 103 will not classify the antonym as a related word.

The related-word generating unit 102 can find the related-words associated with the keyword, and the synonym generating unit 103 can find synonyms of the keyword. The clustering unit 111 receives the related-words outputted from the related-word generating unit 102 and the synonyms outputted from the synonym generating unit 103 to obtain related words of the keyword.

The clustering unit 111 vectorizes the keyword and the related words, so that the keyword and the related words can be converted into computable vector data. The clustering unit 111 individually calculates the respective distance values between the keyword and each related word according to the vectorized keyword and vectorized related words. Moreover, the distance value between two vector data is measured via cosine similarity as the basis for evaluating the degree of similarity between the two vector data. The manner that the keyword and the related words are vectorized and the distance value is calculated between two vector data is well known in the art and is not further discussed. According to calculated distance value, the clustering unit 111 clusters the keyword and the related words to generate clustered results. The clustered results include at least one clustered group. For example, when the distance value between the keyword and one of the related words (such as the first related word) is in close proximity of another distance value between the keyword and another one of the related words (such as the second related word), the clustering unit 111 groups the first and second related words as the same clustered group.

The clustering unit 111 outputs the clustered result onto the operation interface 3, so that the user can select one clustered group from the clustered result. The search engine then filters the initial search result according to the selected clustered group and generates the corresponding filtered search result.

Notably, the processing device 1 can also record the selected clustered group(s) that is (are) selected by the user into a personalized module (not shown in FIG. 1). The personalized module is installed in the processing device 1 and sets the user's personalized settings by deducing user's search preferences according to the records of each clustered group selected by the user. As such, when the user performs the next search, the personalized module automatically filters portions of the web pages according to the user's personalized settings, so that the initial search result further accommodates to the user's preferences.

The instant disclosure does not limit the processing device 1 to execute personalized settings. The users can choose whether to turn on or off the functions associated with the personalized settings. Moreover, the personalized module can also record multiple users' personalized settings. In other words, before a user begins a search, the user can first log-in in to his or her own account via the operation interface 3. The personalized module can also record difference personalized settings for different accounts. At the next search, the personalized module filters the initial search result according to personalized settings corresponding to the current account.

The user first inputs the keyword “pearl”. The search engine 2 then performs the search according to the keyword “pearl” and obtains the corresponding initial search result. The possible related-word generating unit 101 searches the possible related-words corresponding to the keyword “pearl” according to the initial search result. The related-word generating unit 102 and the synonym generating unit 103 separately generates related words according to the frequency in which the keyword “pearl” and the possible related-words co-occurring in the same sentence corresponding to the content article. Related words for example can be “jade”, “hotan jade”, “emerald”, “bracelet”, “pearl milk tea” and “mask”.

The clustering unit 111 vectorizes the keyword “pearl” and the related words, “jade”, “hotan jade”, “emerald”, “bracelet”, “pearl milk tea” and “mask” and calculate individually the distance values between the keyword “pearl” and the related words (jade, hotan jade, emerald, bracelet, pearl milk tea and mask). The clustering unit 111 groups the related words “jade”, “hotan jade”, “emerald”, “bracelet” into a clustered group “jewelry” according to the calculated distance value, groups the related word “pearl milk tea” under a clustered group of “food”, and groups the related word “mask” under a clustered group of “cosmetic”.

The clustering unit 111 then finally outputs the clustered groups of “jewelry”, “food”, and “cosmetic” to the operation interface 3, so that the user can select one of the clustered groups. If the user selects the clustered group “jewelry”, the search engine then filters out the web pages corresponding to the clustered groups “food” and “cosmetic”, and only displays the web pages corresponding to the clustered group “jewelry”

Meanwhile, the personalized module records the clustered group “jewelry” as selected by the user. If the user performs a search next time, the personalized module will control the search engine to first display the web pages corresponding to the clustered group of “jewelry”, or automatically filters out the web pages corresponding to clustered groups other than “jewelry”, so that the initial search result is much more accommodating to the user's preferences.

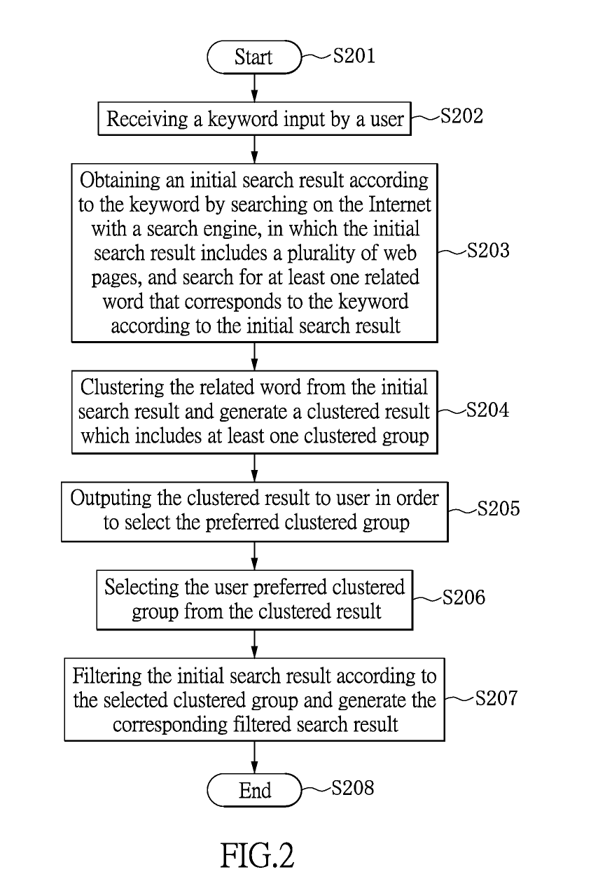

Please refer to FIG. 2 as a process flow diagram illustrating the method for filtering and searching in accordance with an embodiment of the instant disclosure. The searching and filtering method is suitable for the processing device 1 as mentioned above. For step S201, beginning the search and filter method. In step S202, receiving a keyword input by a user. In step S203, obtaining an initial search result according to the keyword by searching online with a search engine. The initial search result includes a plurality of web pages and similar information. Then, searching for at least one related word that corresponds to the keyword according to the initial search result.

In step S204, clustering the related word from the initial search result and generate a clustered result which comprises at least one clustered group. In step S205, outputting the clustered result to the user in order to select the preferred clustered group. In step S206, the user selects the preferred clustered group from the clustered result. In step S207, filtering the initial search result according to the selected clustered group and generating the corresponding filtered search result. Step S208, ending the search and filter method.

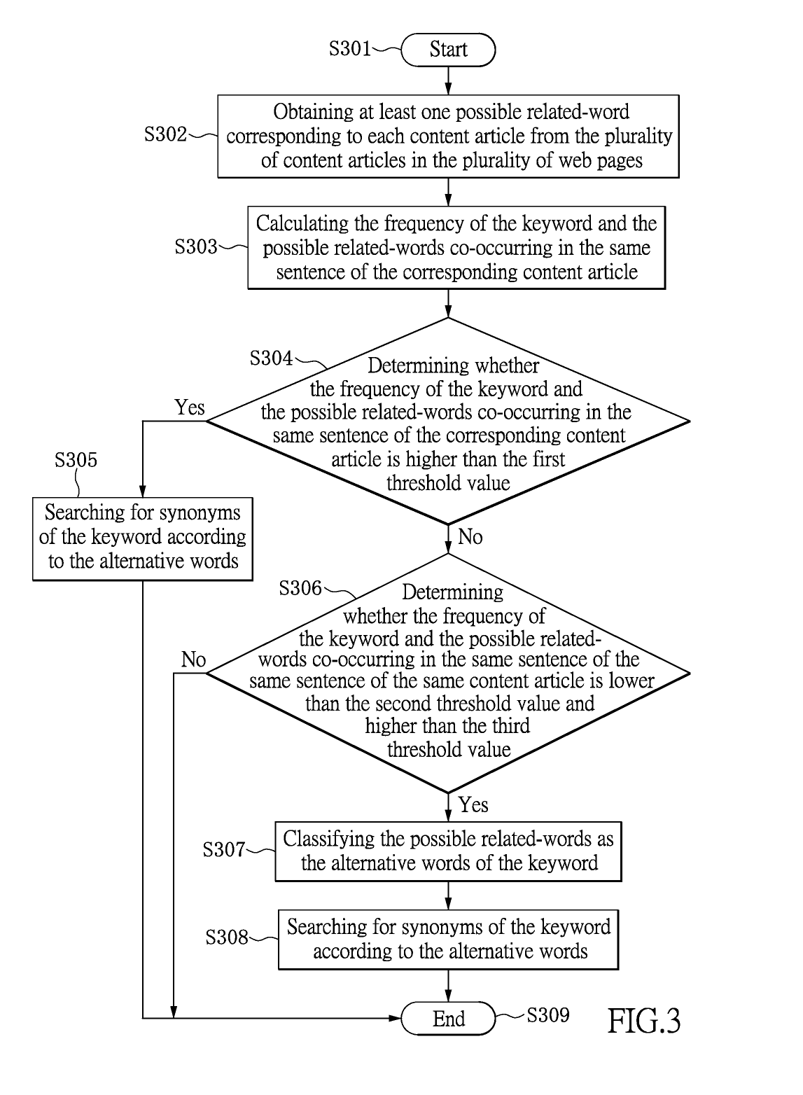

Please refer to FIG. 3 as the process flow diagram illustrating the generation of related words in accordance with an embodiment of the instant disclosure. Step S301 continues from step S203 as shown in FIG. 2, beginning searching for related words corresponding to the keyword. In step S302, obtaining at least one possible related-word corresponding to each content article from the plurality of content articles in the plurality of web pages. The content articles can be any word from the web pages. In step S303, calculating the frequency of the keyword and the possible related-words co-occurring in the same sentence of the corresponding content article.

In step S304, determining whether the frequency of the keyword and the possible related-words co-occurring in the same sentence of the corresponding content article is higher than the first threshold value. If the frequency of the keyword and the possible related-words co-occurring in the same sentence of the corresponding content article is higher than the first threshold value, then step S305 is executed. Conversely, if the lower than the first threshold value, step S306 is executed. As aforementioned, the instant disclosure does not limit the value of the first threshold value, the user can set his or her own first threshold value or generate a preferred value according to relate information in the known art in order to determine the degree of similarity between the keyword and the possible related-words. In step S305, the possible related-words are classified as related words of the keyword.

In step S306, determining whether the frequency of the keyword and the possible related-words co-occurring in the same sentence of the same content article is lower than the second threshold value and higher than the third threshold value. If the frequency of the keyword and the possible related-words co-occurring in the same sentence of the corresponding content article is lower than the second threshold value and higher than the third threshold value, then step S307 is execute, otherwise, step S309 is executed. As aforementioned, the instant disclosure does not limit the values of the second and third threshold values, the user can set his or her own second and third threshold values or generate the preferred values according to the relative information from the known art in order to determine the degree of similarity between the keyword and the possible related-word. For step S307, the possible related-words are classified as the alternative words of the keyword. For step S308, searching for synonyms of the keyword according to the alternative words. For step S309, ending the search for related words corresponding to the keyword.

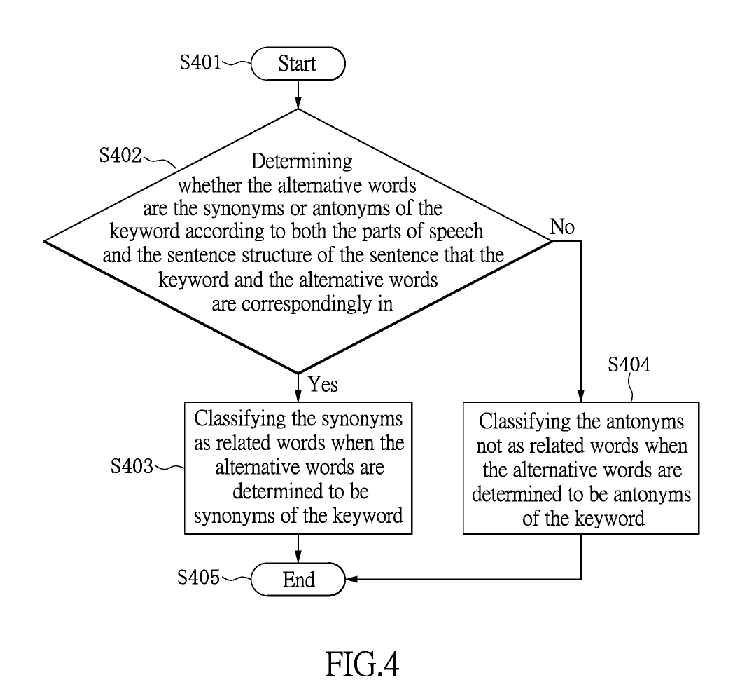

Please refer to FIG. 4 as the process flow diagram illustrating the generation of synonyms in accordance with an embodiment of the instant disclosure. Step S401 continues from step S308 as shown in FIG. 3, beginning searching for synonyms of the keyword according to the alternative words. In step S402, determine whether the alternative words are the synonyms or antonyms of the keyword according to both the parts of speech and the sentence structure of the sentence that the keyword and the alternative words are correspondingly in. The determination on whether the alternative words are the synonyms or the antonyms of the keyword is disclosed in previous embodiment, thus, is not further discussed here. When the alternative words are determined to be the synonyms of the keyword, step S403 is executed, otherwise, step S404 is executed.

In step S403, when the alternative words are determined to be the synonyms of the keyword, the synonyms are classified as related words. In step S404, when the alternative words are determined to be the antonyms of the keyword, the antonyms are not classified as related words. In step S405, ending the search for synonyms of the keyword according to the alternative words.

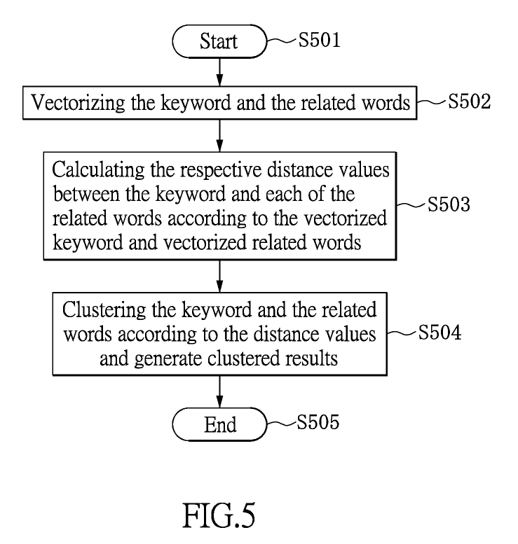

Please refer to FIG. 5 as a process flow diagram illustrating the clustered results in accordance with an embodiment of the instant disclosure. Step S501 continues from step S204 as shown in FIG. 2, beginning clustering the keyword. In step S502, vectorizing the keyword and the related words. In step S503, calculating the respective distance values between the keyword and each of the related words according to the vectorized keyword and vectorized related words. The vectorization of the keyword and related words and the detail calculation of the distance values between the data points are well known to those who have ordinary skilled in the art, thus, are not further disclosed herein. In step S504, clustering the keyword and the related words according to the distance values and generate clustered results. In step S505, ending clustering the keyword.

In summary, the method and the processing device for filtering search results in accordance with the embodiments of the instant disclosure can cluster related words according to initial search results, and generate clustered results. Users can select the desired clustered group(s) from the provided clustered groups according to his or her needs, so that the initial search results can be further filtered and filtered search results that are more preferable to the user are generated.

The method for filtering search results as provided by the instant disclosure can also determine whether the possible related-words are related-words, synonyms or antonyms of the keyword according to the frequency of the keyword and the possible related-words co-occurring in the same sentence of the corresponding content article. The method for filtering search results of the instant disclosure can search for related words of the keyword more accurately in comparison with the existing technology.

Moreover, the processing device in accordance with the embodiments of the instant disclosure further includes a personalized module. With the personalized module, the initial search results obtained from users' searches can be even more closed to users' preferences, so that the users can spend less time on web pages with relatively lower relevance and directly search for the preferred information.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A search results filtering method for a processing device, comprising the steps of:
(a) receiving a keyword;
(b) obtaining an initial search result by searching through a search engine in the internet according to the keyword, and searching at least one related word corresponding to the keyword, wherein the initial search result includes a plurality of web pages;
(c) clustering the related words obtained from the initial search result and generating a clustered result; and wherein the clustered result comprises at least one clustered group;
(d) outputting the clustered result to a user for selecting at least one clustered group; and
(e) filtering the initial search result based on the selected clustered group to correspondingly generate a filtered search result.

2. The method as recited in claim 1, wherein step (b) further comprising the steps of:
(b-1) providing a plurality of content articles including in each of the web pages;
(b-2) obtaining at least one possible related-word correspondingly from each content article; and
(b-3) calculating the frequency of the keyword and the possible related-word co-occurring in the same sentence of the content article, and wherein when the frequency of the keyword and the possible related-word co-occurring in the same sentence is higher than a first threshold value, the possible related-word is classified as the related word.

3. The method as recited in claim 2, wherein step (b) further comprising the step of:
(b-4) classifying the possible related-word as an alternative word of the keyword when the frequency of the keyword and the possible related-word co-occurring in the same sentence is lower than a second threshold value and higher than a third threshold value; determining whether the alternative word is a synonym or an antonym of the keyword based on sentence structure of the sentence including the keyword and the alternative word therein and the part of speech of the keyword and the alternative word; and wherein when the alternative word is determined to be the synonym of the keyword, the synonym is classified as the related word, and when the alternative word is determined to be the antonym of the keyword, the antonym is not classified as the related word.

4. The method as recited in claim 2, wherein the related word is a synonym of the keyword, a related-word associated with the keyword, or a word frequently co-occurring with the keyword in the same sentence of the same content article.

5. The method as recited in claim 1, wherein step (c) further comprising the steps of:
(c-1) vectorizing the keyword and the related word;
(c-2) calculating a distance between the vectors of keyword and the related word; and
(c-3) clustering the keyword and the related word according to the distance and generating the clustered result.

6. The method as recited in claim 1, wherein step (e) further comprising the steps of:
(e-1) recording the user selected clustered group as a personalized setting of the user.

7. The method as recited in claim 1, wherein the processing device is compatible with any search engine or a recommendation system.

8. A processing device, comprising:
a related word generating module receiving a keyword input by a user, an initial search result retrieved by searching through a search engine in the internet; wherein at least one related word corresponding to the keyword is searched, and the initial search result includes a plurality of web pages; and
a clustering unit electrically connected to the related word generating module to cluster the related words obtained from the initial search result and generate a clustered result, and the clustered result including at least one clustered group;
wherein the clustering unit outputs the clustered result to an operational interface for the user to choose one clustered group, and the search engine filters the initial search result according to the clustered group selected by the user to correspondingly generate a filtered search result.

9. The device as recited in claim 8, wherein the related word generating module further comprising:
a possible related-word generating unit electrically connected to the search engine for obtaining at least one possible related-word from each of a plurality of content articles included in each of the web pages.

10. The device as recited in claim 9, wherein the related word generating module further comprising:
a related-word generating unit electrically connected to the possible related-word generating unit for generating the related word according to the frequency of the keyword and the possible related-word co-occurring in the same sentence of the content article; and wherein when the frequency of the keyword and the possible related-word co-occurring in the same sentence is higher than a first threshold value, the possible related-word is classified as the related word.

11. The device as recited in claim 9, wherein the related word generating module further comprising:
a synonym generating unit electrically connected to the possible related-word generating unit for generating an alternative word according to the frequency of the keyword and the possible related-word co-occurring in the same sentence of the content article; wherein when the frequency of the keyword and the possible related-word co-occurring in the same sentence is lower than a second threshold value and higher than a third threshold value, the possible related-word is classified as the alternative word of the keyword;
wherein the synonym generating unit determines whether the alternative word is a synonym or an antonym of the keyword based on sentence structure of the sentence including the keyword and the alternative word therein and the part of speech of the keyword and the alternative word; and wherein when the alternative word is determined to be a synonym of the keyword, the synonym is classified as the related word, and when the alternative word is determined to be an antonym of the keyword, the antonym is not classified as the related word.

12. The device as recited in claim 9, wherein the related word is a synonym of the keyword, a related-word associated with the keyword, or a word frequently co-occurring with the keyword in the same sentence of the same content article.

13. The device as recited in claim 8, wherein the keyword and the related word are vectorized by the clustering unit, the clustering unit calculates a distance between the vectors of keyword and the related word after vectorizing, and the clustering unit clusters the keyword and the related word according to the distances and generates the clustered result.

14. The device as recited in claim 8, wherein the processing device records the clustered group selected by the user as a personalized setting of the user.

15. The device as recited in claim 8, wherein the processing device is compatible with any search engine or recommendation system.
